(19) United States
(12) Patent Application Publication
(10) Pub. No.: US 2004/0015502 A1
(43) Pub. Date: Jan. 22, 2004

(54) Application program interface for programmable architecture cores

(76) Inventors: John Alexander, Abingdon (GB); Hammad Hamid, Slough Berkshire (GB)

Correspondence Address: SILICON VALLEY INTELLECTUAL PROPERTY GROUP, P.O. BOX 721120, SAN JOSE, CA, 95172-1120, US

(21) Appl. No.: 09/872,167

(22) Filed: May 31, 2001

Related U.S. Application Data
(63) Continuation-in-part of application No. 09/772,710, filed on Jan. 29, 2001, now abandoned.

(51) Int. Cl. G06F 9/44

(52) U.S. Cl. 707/100; 717/147

(57) ABSTRACT

A system and computer program product are provided for allowing an application to be integrated with any one of a plurality of distinct types of programmable platforms. First included is a platform-independent application and a platform-independent interface. The platform-independent interface is capable of interfacing the platform-independent application with any one of the distinct types of programmable platform. The programmable platform is further equipped with a platform-dependent interface. This platform-dependent interface serves in conjunction with the platform-independent interface in providing the interface between the platform-independent application and the programmable platform. As such, a versatile framework is provided that allows the reuse of the platform-independent application on numerous different types of programmable platforms.

### RELATED APPLICATIONS

This application is a continuation-in-part of an application entitled “SYSTEM, METHOD AND ARTICLE OF MANUFACTURE FOR USING A LIBRARY MAP TO CREATE AND MAINTAIN IP CORES EFFECTIVELY” which was filed Jan. 29, 2001 under Ser. No. 09/772,710, which is incorporated herein by reference in its entirety for all purposes.

### FIELD OF THE INVENTION

The present invention relates to programmable platform architectures and more particularly to providing a methodology for coding for programmable platform architectures in a platform independent manner.

### BACKGROUND OF THE INVENTION

Traditionally, an application programming interface (API) includes calling conventions by which an application program accesses an operating system and other services. An API is defined at the source code level and provides a level of abstraction between the application and the kernel (or other privileged utilities) to ensure the portability of the code.

An API can also provide an interface between a high level language and lower level utilities and services that were written without consideration for the calling conventions supported by compiled languages. In this case, the API's main task may include the translation of data from one format to another or one protocol to another.

FPGAs are gate arrays which can be repeatedly reprogrammed while remaining in their environment of use (e.g., while mounted in the circuit board in which it is intended to be used). FPGAs typically include programmable logic blocks (e.g., programmable Boolean logic gates), and may also include programmable memory blocks, programmable clocking blocks, and other specialized programmable blocks such as multiplier blocks and I/O ports. Examples of commercially available FPGAs include those manufactured and distributed by the XILINX, Inc., such as the Spartan II Series and Virtex Series FPGAs.

Typically, FPGAs are programmed using a programming language specific to hardware, such as the Verilog HDL (Hardware Description Language) or the VHSIC HDL (often referred to as VHDL). These programming languages are generally used to implement specific hardware logic which is desired in the FPGA. As an example, the VHDL statement “ADD<=A1+A2+A3+A4” could be used to add signals A1 through A4. After the logic has been coded in HDL, it is synthesized to a bit stream. The FPGA can then be programmed by writing the bit stream to the FPGA.

HDLs thus provide a method of generating code that is reasonably independent from the FPGA architecture. However, it is well known that HDLs cannot be “platform-independent” which requires support for the vast variety of peripheral components that might be found connected to the FPGA. Further, the compiler, or synthesis tool, cannot be platform-independent. Therefore, the HDL must be compiled uniquely for differing FPGAs. Furthermore, even if the FPGA remains the same, a change to any of the other platform components such as hardware resources or peripherals require that the application be rewritten to use the new peripheral(s). These features inhibit the reuse of applications on different FPGA platforms. Since FPGAs are found in an increasingly wide variety of systems, a technique of generating platform-independent code is desirable. In traditional systems, platform-independence for applications is commonly provided by an operating system. Unfortunately, an FPGA has no operating system.

Prior art FIG. 1 illustrates one difficultly associated with the platform-dependence of applications executed on FPGAs. As shown in FIG. 1, FPGA Platform 1 may include a first generation of a product or reference board produced by a company. FPGA Platform 2 may include a second generation of the board produced by the company. To port the system produced for FPGA Platform 1 to FPGA Platform 2 requires a large amount of effort since a new interface must be written for each new peripheral. FPGA Platform 3 represents a possible future platform. Again, much effort is required to port the system produced for FPGA Platform 2 to FPGA Platform 3. In view of this difficulty, there is a need for an interface framework including platform-independent code which may easily be utilized in the context of FPGA Platform 1, FPGA Platform 2, FPGA Platform 3 or any programmable platform.

### SUMMARY OF THE INVENTION

A system and computer program product are provided for allowing an application to be integrated with any one of a plurality of distinct types of programmable platforms. First included are a platform-independent application and a platform-independent interface. The platform-independent interface is capable of interfacing, at least in part, the platform-independent application with any one of the distinct types of programmable platform. The programmable platform is further equipped with a platform-dependent interface. This platform-dependent interface serves in conjunction with the platform-independent interface in providing the interface between the platform-independent application and the programmable platform. As such, a versatile framework is provided that allows the reuse of the platform-independent application on numerous different types of programmable platforms.

In one embodiment of the present invention, the platform-dependent interface may include a library of platform-dependent resource interfaces which are wrapped with a standard interface capable of being accessed by the platform-independent interface. Further, the platform-independent application may be specifically written to use the platform-independent interface.

In another embodiment of the present invention, the interface between the platform-independent application and the programmable platform may be customized. For example, the specific port requirements of the platform-independent application may be accommodated in a customizable manner. Moreover, peripherals may be included and excluded based on the requirements of the platform-independent application. Still yet, the memory resources required by the platform-independent application may be dedicated.

In another aspect of the present embodiment, the interface may be customized in accordance with user-specified criteria. In such aspect, a graphical user interface may be provided for allowing a user to enter the user-specified criteria.

In another embodiment of the present invention, a plurality of the applications may be included. Each application may thus be equipped with a unique platform-independent application, and a single platform-independent interface including a plurality of plugs. Further, the platform-dependent interface of the programmable platform may include a plurality of sockets allocated to the plugs.

In still another embodiment of the present invention, the programmable platform may include a field programmable gate array (FPGA). Further, the platform-independent interface may be written in a C-based variant programming language.

### BRIEF DESCRIPTION OF THE DRAWINGS

The invention will be better understood when consideration is given to the following detailed description thereof. Such description makes reference to the annexed drawings wherein:

Prior art FIG. 1 illustrates the difficultly associated with the platform-dependence of applications executed on FPGAs.

FIG. 2 illustrates a framework for allowing an application to be integrated with any one of a plurality of distinct types of programmable platforms, wherein the application is shown to be integrated with a first type of programmable platform.

FIG. 2A illustrates the framework of FIG. 2, wherein the application is shown to be integrated with a second type of programmable platform.

FIG. 2B illustrates the framework of FIG. 2, wherein a plurality of applications are shown to be integrated with a programmable platform.

FIG. 2C illustrates the framework of FIG. 2, wherein a plurality of specific exemplary applications are shown to be integrated with a specific exemplary programmable platform.

FIG. 3 shows a lower level view of a possible linkage between the platform-independent application and the platform-dependent interface.

FIG. 4 illustrates a method to produce a bit-stream for a programmable platform.

FIG. 5 illustrates the file relationships that may be used to generate the system of the present invention, in accordance with one exemplary embodiment.

FIG. 6 illustrates an exemplary embodiment of the present invention.

### DETAILED DESCRIPTION OF THE PREFERRED EMBODIMENTS

One aspect of the present invention involves an application program interface that permits the generation of platform-independent code that may be used with different types of programmable platforms. By this design, the present invention is capable of allowing code to be conveniently reused from one programmable platform to another.

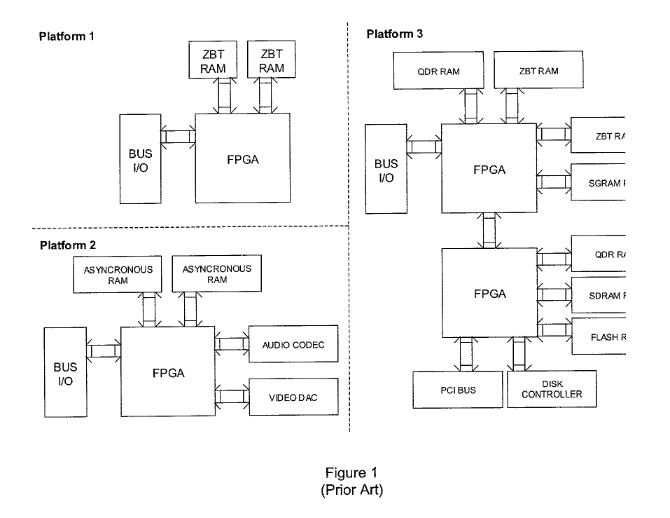

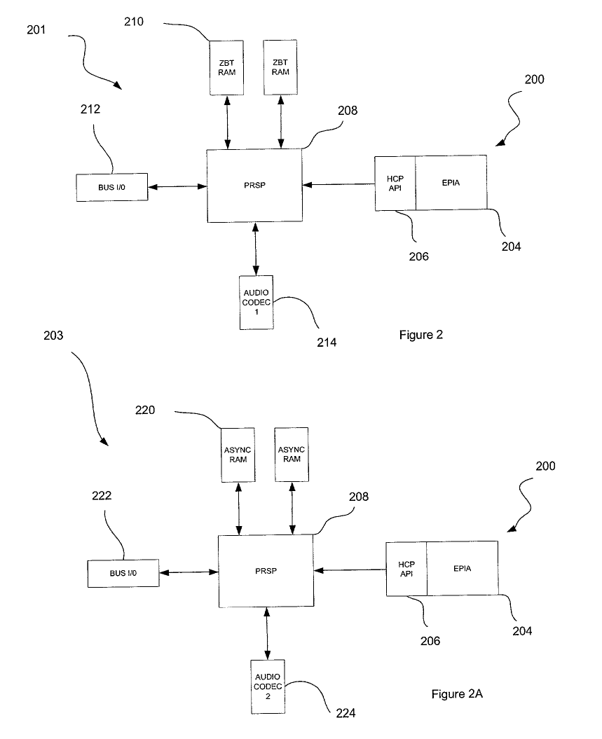

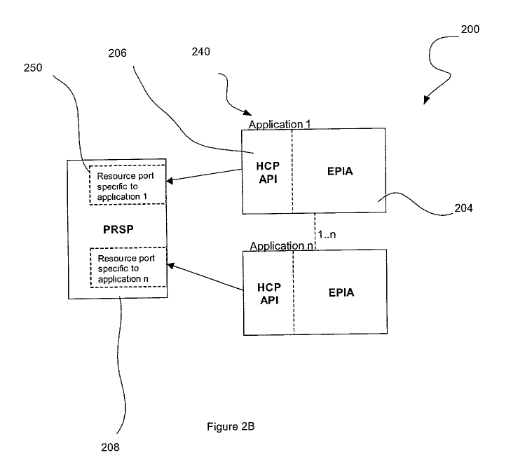

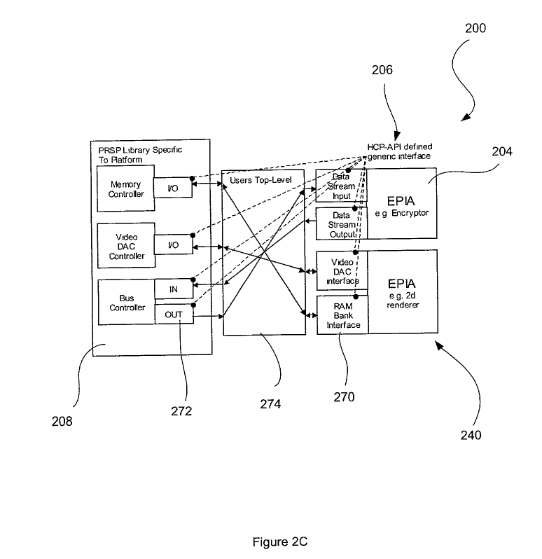

FIG. 2 illustrates a framework 200 for allowing a platform-independent application 204 to be integrated with any one of a plurality of distinct types of programmable platforms. As shown, the platform-independent application 204 is integrated with a first type of programmable platform 201 which includes a first type of memory 210, a bus I/O 212, and a first type of audio decoder 214. It should be understood that the first type of programmable platform 201 is merely exemplary of one possible programmable platform. Of course, any type of programmable platform 201 may be employed per the desires of the user. The manner in which the platform-independent application 204 is conveniently integrated with a second type of programmable platform will be set forth later during reference to FIG. 2A.

In the present description, a programmable platform refers the programmable hardware including resources situated on the hardware. Programmable hardware may refer to a field programmable gate array (FPGA), or any hardware that is programmable. Resources situated on the hardware may include application resources such as memory or an audio codec as well as interfaces to peripheral devices such as an i/o bus. Further, different “types” of programmable platforms may differ by any variation in the programmable platform itself and/or in an associated environment. Further, the platform-independent application 204 may be integrated with the programmable platform by being implemented thereon, implemented on an associated device in a “co-development environment,” or integrated in any other desired manner.

Examples of FPGAs include the XC2000™, XC3000™, XC4000™, and/or Virtex families of FPGA devices introduced by Xilinx, Inc. of San Jose, Calif. The architectures of these devices are exemplified in U.S. Pat. Nos. 4,642,487; 4,706,216; 4,713,557; and 4,758,985; each of which is originally assigned to Xilinx, Inc. and which are herein incorporated by reference for all purposes. It should be noted, however, that FPGAs of any type may be employed in the context of the present invention.

With continuing reference to FIG. 2, further included is a platform-independent interface 206. By being “platform-independent,” the platform-independent application 204 and the platform-independent interface 206 are written/configured universally in a manner that is independent of any particular type of programmable platform.

The platform-independent application 204 may be specifically written to use the platform-independent interface 206. In one embodiment, this is accomplished by defining a set of macros and functions that may be used to form and access generic interfaces to platform resources (i.e. resources that are specific to particular programmable platform and possibly the peripheral components connected thereto, etc.).

The platform-independent interface 206 is designed based on a standard predetermined format. In use, the platform-independent interface 206 is capable of providing, at least in part, an interface between the platform-independent application 204 and any one of the distinct types of programmable platforms.

With reference again to FIG. 2, it is shown that the programmable platform is further equipped with a platform-dependent interface 208. Such platform-dependent interface 208 is specifically written for the programmable platform and further serves in conjunction with the platform-independent interface 206 in interfacing the platform-independent application 204 and the programmable platform. By being “platform-dependent,” the platform-dependent interface 208 is written/configured specifically based on a specific type of programmable platform including interfaces to the hardware resources and peripherals that will be used by the platform-independent application 204.

In use, the platform-dependent interface 208 provides a collection of interfaces to platform resources wrapped with a common interface. The interfaces may include a memory chip interface, a video DAC interface, an interface to a bus of some description, or any other desired interface. In one embodiment, a bus interface may be provided which is customized to facilitate co-processing. As such, a co-processor may be reduced to a component inside the platform-dependent interface 208.

The platform-dependent interface 208 further provides a method of collecting all of such interfaces, and storing them in a common library. The common library is then given a standard interface for each type of platform resource for allowing communication with the standard format of the platform-independent interface 206.

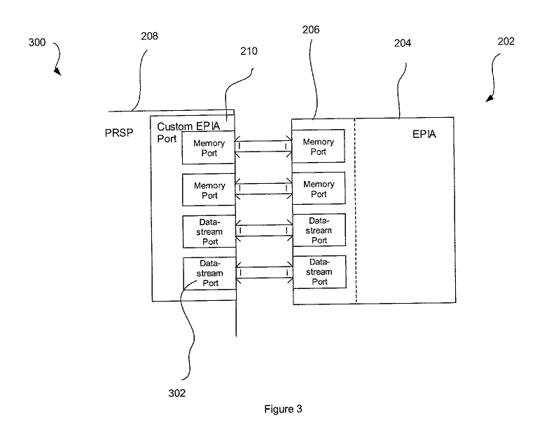

As mentioned earlier, the platform-independent interface 206 includes a standard set of functions/macros that provide access to one or more of the aforementioned interfaces of the platform-dependent interface 208. The actual implementation of the connection formed can be of any format required providing that the platform-dependent interface 208 supports the connection method. As such, the flexibility of the present technique is extended. More information regarding the linkage between the platform-independent application 204 and the platform-dependent interface 208 will be set forth hereinafter in greater detail during reference to FIG. 3.

By this design, a versatile framework is provided that allows the reuse of the platform-independent application 204 on numerous different types of programmable platforms. One exemplary reuse of the platform-independent application 204 will be set forth later during reference to FIG. 2A.

In one embodiment, the platform-independent interface 206 may be characterized as an Engineered Platform Independent Application (EPIA). As an option, the platform-independent interface 206 may be written in Handel-C programmable language. In such embodiment, the platform-independent interface 206 may be referred to as a Handel-C Platform Application Program Interface (HCP-API). Still yet, the platform-dependent interface 208 may be referred to as a Platform Resource Support Package (PRSP).

More information regarding the Handel-C programming language may be found in “Celoxica Handel-C Language Reference Manual: Version 3,” “Celoxica Handel-C User Manual: Version 3.0,” “Celoxica Handel-C Interfacing to other language code blocks: Version 3.0,” each authored by Rachel Ganz, and published by Celoxica Limited in the year of 2001; and “EMBEDDED SOLUTIONS Handel-C Preprocessor Reference Manual: Version 2.1,” also authored by Rachel Ganz and published by Embedded Solutions Limited in the year of 2000; and which are each incorporated herein by reference in their entirety. Additional information may also be found in a co-pending application entitled “SYSTEM, METHOD AND ARTICLE OF MANUFACTURE FOR USING A LIBRARY MAP TO CREATE AND MAINTAIN IP CORES EFFECTIVELY” which was filed Jan. 29, 2001 under Ser. No. 09/772,710, and which is incorporated herein by reference in its entirety.

It should be understood that other programming and hardware description languages may be utilized as well. In particular, in one embodiment it is preferred to utilize a “C-based variant programming language,” which refers to any programming language which generally follows the conventions of the C programming language with adaptations suitable for programming reprogrammable platforms. Examples of a C-based variant programming language include Handel-C, Bach-C, and any other programming language meeting the above criteria.

FIG. 2A illustrates the framework of FIG. 2, wherein the application 204 is shown to be integrated with a second type of programmable platform 203. As shown, the second type of programmable platform 203 may include a second type of memory 220, a bus I/O 222, and a second type of audio decoder 224.

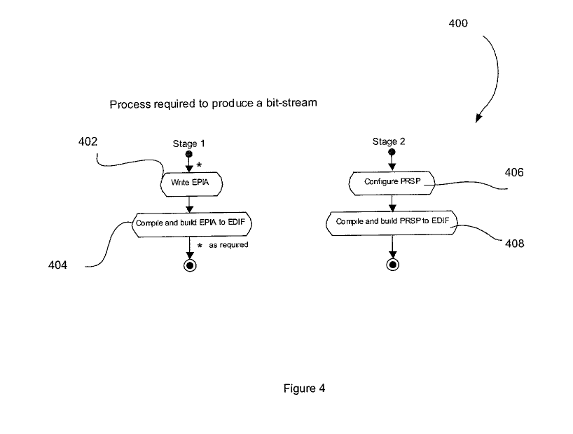

In order to integrate the application 204 with the new type of programmable platform 203, a new platform-dependent interface 208 is first configured to reflect the resources of the programmable platform 203. This may require the development of new modules for the platform-dependent interface 208 designed specifically to interface with the new resources. However, since the interface between the platform-independent interface 206 and the platform-dependent interface 208 is standardized, an interface module previously developed for the same resource can be incorporated in the platform dependent interface 208 without modification. The process of configuring the platform dependent-interface 208 to use the correct resources may be facilitated by use of a graphical user interface described later. It may also be facilitated by a method of using library maps set forth in the co-pending application entitled “SYSTEM, METHOD AND ARTICLE OF MANUFACTURE FOR USING A LIBRARY MAP TO CREATE AND MAINTAIN IP CORES EFFECTIVELY” referenced above. Further, the application 204 is recompiled in the context of the new platform-dependent interface 208. More information regarding such process will be set forth hereinafter in greater detail during reference to FIG. 4.

As can be noted above, the second type of programmable platform 203 includes components that generally correspond to those of the first type of programmable platform 201 of FIG. 2. In cases where the programmable platforms include fewer or additional components, measures may be taken to ensure that the application 204 is capable of operating using the available resources. For example, the platform-dependent interface 208 may dedicate memory resources required by the platform-independent application 204.

By this design, the amount of effort required to port applications from one FPGA platform to another is reduced. This, in turn, enables easier construction of systems on a semiconductor platform.

FIG. 2B illustrates the framework of FIG. 2, wherein a plurality of applications 240 are shown to be integrated with a single programmable platform. Each platform-independent application 204 may thus be designed for a unique purpose. Further, each platform-independent application 204 may include a platform-independent interface 206 similar to the platform-independent interfaces 206 of the other applications 204. Further, the platform-dependent interface 208 associated with the programmable platform may include a plurality of ports 210 each associated with one of the applications 204.

FIG. 2C illustrates the framework of FIG. 2, wherein a plurality of specific exemplary applications 240 are shown to be integrated with a specific exemplary programmable platform. As shown, each platform-independent application 204 are designed for a unique purpose, i.e. an encrypting and rendering. Further, each platform-independent application 204 includes a platform-independent interface 206 including a plurality of “plugs” 270 that allow the platform-independent applications 204 to interface resources of the programmable platform in a generic manner. As shown in the specific example of FIG. 2C, such resources may include a memory controller, video DAC controller, and bus controller.

The platform-dependent interface 208 associated with the programmable platform may include a plurality of “sockets” 272 allocated to the plugs 270 of the platform-independent interface 206. As such, the aforementioned ports 210 may be viewed as having two portions, namely a plug portion and a socket portion.

It should be noted that such allocation of the sockets 272 to the plugs 270 may be set forth in a top level file 274 used to instantiate the applications 240. When the programmable platform is to be changed, only this top level file 274 needs to be altered to accommodate this change.

FIG. 3 shows a lower level view 300 of a possible linkage between the platform-independent application 204 and the platform-dependent interface 208. As shown, each port 210 identifies actual ports 302 based on the specific requirements of the platform-independent application 204. Such ports 302 may include memory ports, data-stream ports, etc. Table 1 illustrates the various ports that may be supported in one embodiment.

TABLE 1

Data Streaming
Memory Access (On chip or Off chip)
Message Sending
Message Receiving
Basic Video DAC Interface
Bus Interface

For a feature to be available (e.g. Memory access), the hardware should have the required resources.

In one embodiment, the platform-independent interface 206 may be configured to customize the interface by enabling/disabling a plurality of peripherals, i.e. external bus, video DAC, ZBT memory chip, async memory chip, video capture chip, etc. The exact configuration may depend on the particular programmable platform being used. It should be noted that the foregoing feature is especially useful where I/O connectors are used to provide optional functionality. Other options may include dedication of memory resources or multi-porting of memory resources.

As an option, the platform-dependent interface 208 may be capable of customizing the interface in accordance with user-specified criteria. In such aspect, a graphical user interface may be provided for allowing a user to enter the user-specified criteria. Such criteria may involve any of the parameters, peripherals, ports, etc. set forth hereinabove. The application associated with the graphical user interface further generates a code base for the platform-dependent interface 208 which is configured to the specific user requirements. Use of the graphical user interface thus enables the inclusion of future, more complex configuration features, thus expanding flexibility.

The platform-dependent interface 208 is thus both configurable and extendable. Such allows features to be implemented as required by the user. Data streaming and message sending may be provided to allow easy, compatible and efficient communication between the platform-independent application 204 and other resources, i.e. an external bus. The implementation of the features of the platform-independent interface 206 is also flexible. This flexibility allows, for example, a video engine to be used on programmable platform with no video output hardware. This may be useful if the image is to be sent to other programmable platform to be displayed.

In one embodiment within the context of the aforementioned Handel-C programming language, the platform-dependent interface 208 may include a Handel-C library and a header file that contains interfaces to the resources of the programmable platform. The Handel-C library and header may be used to create a source file that forms a top-level for a system. It is this top-level source file that creates the instances of the platform-independent application 204. The header file may further include macros for creating and customizing the interfaces to the platform-independent application 204. It is possible for the interface to the platform-independent application 204 to have different port requirements depending on functionality, thus warranting the use of such technique. The platform-dependent interface 208 may also be at the top-level as it is possible for data streaming ports and messaging ports to be interconnected with the platform-independent application 204.

FIG. 4 illustrates a method 400 to produce a bit-stream for the programmable platform. As shown, the method 400 includes writing the platform-independent application 204, wherein the plafform-independent application 204 is further equipped with the platform-independent interface 206. See act 402. Thereafter, in act 404, the platform-independent application 204 is compiled into a predetermined format, i.e. EDIF, etc.

The platform-dependent interface 208 is then configured in act 406 for serving in conjunction with the platform-independent interface 206 in providing the interface between the platform-independent application 204 and programmable platform. Next, in act 408, the platform-dependent interface 208 is compiled into the predetermined format.

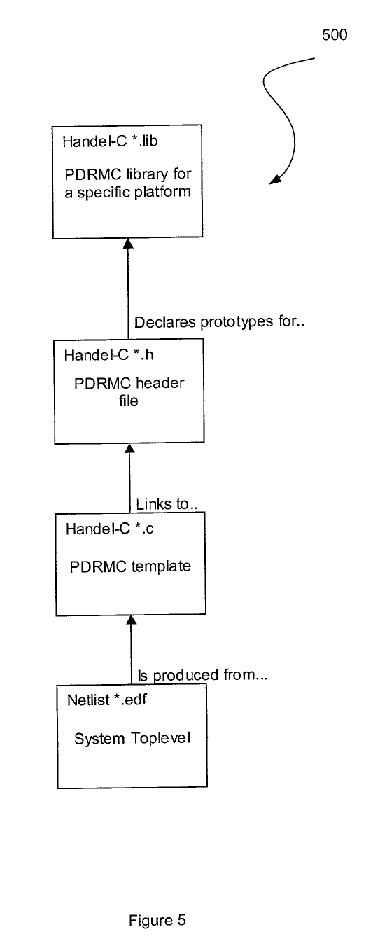

It should be noted that acts 402-404 may be separated from acts 406-408 to form two different stages. FIG. 5 illustrates the file relationships 500 that may be used to generate the system of the present invention, in accordance with one exemplary embodiment.

With reference again to FIG. 1, a solution has thus been provided for a versatile framework that allows the reuse of the platform-independent application 204 on numerous different types of programmable platforms. A general example of use of such solution will now be set forth in the context of FIG. 1. As mentioned earlier, FPGA Platform 1 includes a first generation of a product or reference board produced by a company. FPGA Platform 2 may include a second generation of the board produced by the company.

To port the system produced for FPGA Platform 1 to FPGA Platform 2 would normally require a large amount of effort. If, however, the system has been designed so that the application in the systems of FIG. 1 constitute a platform-independent application 204 in accordance with the foregoing descriptions, the porting effort is much reduced. To port the platform-independent application 204 all that is required is the presence of the platform-dependent interface 208 for the target hardware.

The platform-dependent interface 208 is not necessarily application-specific and thus only needs to be produced once for each platform. For the platform-independent application 204 to function with a particular platform-dependent interface 208 requires only that the platform-dependent interface 208 supports the requirements for performance and functionality that the platform-independent application 204 requires. The port types may specify the functionality requirements of the platform-independent application 204.

A specific example of an implementation of the present invention will now be set forth in the context of the EPIA (platform-independent application 204), HCP-API (platform-independent interface 206) and PRSP (platform-dependent interface 208) set forth hereinabove. It should be noted that the present example is illustrative in nature, and should not be construed as limiting in any manner.

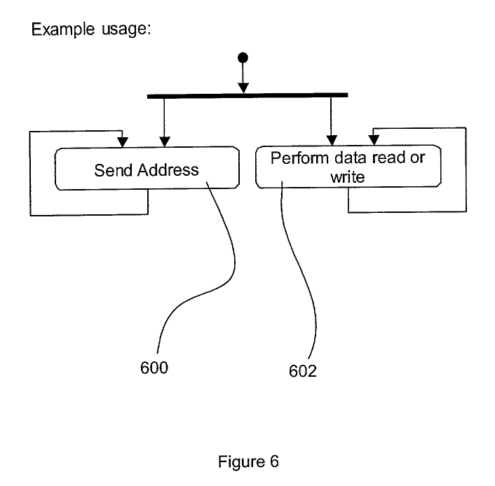

Table 2 illustrates an exemplary interface for a split phase memory access controller which may be defined by the platform-independent interface 206. As shown in FIG. 6, address cycles 600 and data cycles 602 are treated separately. This allows efficient and low delay access to an external memory device. This technique also allows support for memory devices that do not return data within the same clock cycle that the address was issued. In use, the data cycles 602 lock until an address cycle 600 has been processed.

TABLE 2
macro proc HCPAPISetAddress (UniqueBankHandle, Address,
ReadNotWrite);

UniqueHandle:

This is the name of a port created prior to the

use of this routine.

Address:

This is a value represents the address location to

be accessed.

ReadNotWrite:

This value represents the direction of the memory

transfer operation.

1 = Read, 0 = Write.

macro proc HCAPIMemoryRead (UniqueBankHandle, DataValue);

UniqueBankHandle:

This is the name of a port created prior to the

use of this routine.

DataValue:

This is a pointer to a register that will be used
to store the data read from the memory port.

macro proc HCPAPIMemoryWrite (UniqueBankHandle, DataValue);

UniqueBankHandle:

This is the name of a port created prior to the

use of this routine.

DataValue:

This is a pointer to a register that the data to
be written will be taken from.

Table 3 illustrates exemplary code usage that may be utilized by the platform-independent application 204 to utilize the interface of Table 2.

TABLE 3

while(1)
{

par
{

if(AddressValueValid == 1)
{

// Use the HCP API routine to send a

memory address...

HCPAPISetAddress (BankHandle,

AddressValue, MemoryTransferDirection);

}
else delay;

}
par
{

if (AddressValueValid &

MemoryTransferDirection)

{

// Use the HCP API routine to perform

a memory read...

HCPAPIReadMemory (BankHandle,

&MemoryReadBuffer);

}
else if(AddressValueValid &

(˜MemoryTransferDirection))

{

// Use the HCP API routine to perform

a memory write...

HCPAPIWriteMemory (BankHandle,

&MemoryWriteBuffer);

}
else delay;

}

}

While the platform-dependent interface 208 may be generated manually, it is more efficient if a code wizard is used. Such code generation wizard may be included with the platform-dependent interface 208 as an application included with libraries associated with the platform-dependent interface 208. Table 4 illustrates a usage example.

TABLE 1
#include “TopLevelInclude.h”
#include “prsp.h”
#include “DemoEPIA1.h
// Initialise this top-level module. It is possible to have
more than one
// top-level module.
HCPAPI_INITIALISE_TOP_LEVEL( TemporaryClockSource )
// Create two instances of the LED flasher module (it is
called DemoModule1).
HCPAPI_CREATE_MODULE_INSTANCES( DemoModule1, 2 )
// Define the main function for this module...
void main()

// The instances of the EPIA should be executed in

parallel...

par
{

// Run instance 0 of DemoModule1, connect it to

LEDResource0...

// NOTE: the names of the resources a platform

supports will be provided

// in documention provided with a PRSP.
// Set the flashing interval to 10000000...
HCPAPI_EXECUTE_MODULE( DemoModule1 ) ( 0,

LEDResource0, 10000000 );

// Run instance 1 of DemoModule1, connect it to

LEDResource1...

// NOTE: the names of the resources a platform

supports will be provided

// in documention provided with a PRSP.
// Set the flashing interval to 20000000...
HCPAPI_EXECUTE_MODULE( DemoModule1 ) ( 1,

LEDResource1, 20000000 );

}

}

#include “DemoEPIA1.h”
#include “EPIAInclude.h”
// Initialise the EPIA module, you can put more than one EPIA
in a source file or library if required...
HCPAPI_INITIALISE_MODULE( DemoModule1 )
// Declare a function that is used by an EPIA module. This
allow the mechanism to keep track
// of multiple instances of the module and create multiple
copies of functions used by an EPIA...
HCPAPI_DECLARE_FUNCTION( DemoModule1, DemoFunction1,
unsigned int 1 ) ( unsigned int 1 Parameter );
// Define the entry point for the EPIA...
HCPAPI_ENTRY_POINT( DemoModule1 ) ( InstanceID,
AnLEDResource, FlashDelay )
{

// Declare a couple of variables(registers) for the EPIA

functionality...

static unsigned int 1 LEDStatus = 0;
static unsigned int 32 Timer = 0;
while(1)
{

if( Timer == FlashDelay )
{

par
{

// Calculate the new LED status using
LEDStatus = HCPAPI_EXECUTE_FUNCTION(

DemoFunction1, InstanceID ) ( LEDStatus );

// Use the LE resource worker macro to updata

the LED status...

HCPAPISetLEDResourceStatus ( AnLEDResource,

LEDStatus );

// Reset the timer...
Timer = 0;

}

}
else Timer++;

}

}
// Define a function that is used by the EPIA, see declaration
above...
HCPAPI_DEFINE_FUNCTION( DemoModule1, DemoFunction1,
unsigned int 1 ) ( unsigned int 1 Parameter
{

// This function inverts the input and returns it...
return( ˜Parameter );

}

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A system for allowing an application to be integrated with any one of a plurality of distinct types of programmable platforms, the system comprising:
(a) a platform-independent application capable of being integrated with any one of a plurality of distinct types of programmable platform;
(b) a platform-independent interface capable of interfacing, at least in part, the platform-independent application with any one of the distinct types of programmable platforms; and
(c) a platform-dependent interface situated on a predetermined programmable platform and capable of serving in conjunction with the platform-independent interface in interfacing the platform-independent application with the predetermined programmable platform.

2. A system as recited in claim 1, wherein the platform-dependent interface is specifically written to interface with the predetermined programmable platform.

3. A system as recited in claim 2, wherein the platform-dependent interface includes a library of platform-dependent resource interfaces which are wrapped with a standard interface capable of being accessed by the platform-independent interface.

4. A system as recited in claim 1, wherein the platform-independent application is specifically written to interface with the platform-independent interface.

5. A system as recited in claim 1, wherein the interface between the platform-independent application and the programmable platform is capable of being customized.

6. A system as recited in claim 5, wherein the interface is customized by accommodating the specific port requirements of the platform-independent application.

7. A system as recited in claim 5, wherein the interface is customized by including and excluding peripherals based on the requirements of the platform-independent application.

8. A system as recited in claim 5, wherein the interface is customized by dedicating memory resources required by the platform-independent application.

9. A system as recited in claim 5, wherein the interface is capable of being customized in accordance with user-specified criteria.

10. A system as recited in claim 9, wherein a graphical user interface is provided for allowing a user to enter the user-specified criteria.

11. A system as recited in claim 1, wherein a plurality of the applications are included each with a unique platform-independent application utilizing a single platform-independent interface including a plurality of plugs.

12. A system as recited in claim 11, wherein the platform-dependent interface of the programmable platform includes a plurality of sockets allocated to the plugs.

13. A system as recited in claim 11, wherein the platform-dependent interface of the programmable platform is capable of reserving resources for each of the applications.

14. A system as recited in claim 1, wherein the programmable platform includes a field programmable gate array (FPGA).

15. A system as recited in claim 1, wherein the platform-independent interface is written in a C-based variant programming language.

16. A system comprising:
(a) a plurality of unique platform-independent applications;
(b) a platform-independent interface capable of interfacing, at least in part, the platform-independent applications with any one of a plurality of distinct types of programmable platforms; and
(c) a platform-dependent interface situated on a predetermined programmable platform and capable of serving in conjunction with the platform-independent interface in interfacing the platform-independent applications and the predetermined programmable platform.

17. A method for allowing an application to be integrated with any one of a plurality of distinct types of programmable platforms, the method comprising:
(a) providing a platform-independent application capable of being integrated with any one of a plurality of distinct types of programmable platform;
(b) interfacing the platform-independent application with any one of the distinct types of programmable platforms utilizing a platform-independent interface at least in part; and
(c) interfacing the platform-independent application with a predetermined programmable platform utilizing a platform-dependent interface situated on the predetermined programmable platform at least in part.

18. A computer program product for allowing an application to be integrated with any one of a plurality of distinct types of programmable platforms, the computer program product comprising:
(a) a platform-independent application capable of being integrated with any one of a plurality of distinct types of programmable platform;
(b) platform-independent computer code for interfacing, at least in part, the platform-independent application with any one of the distinct types of programmable platforms; and
(c) platform-dependent interface computer code situated on a predetermined programmable platform for interfacing, at least in part, the platform-independent application with the predetermined programmable platform.

19. A system comprising:
(a) a platform-independent application capable of being integrated with any one of a plurality of distinct types of programmable platform;
(b) a platform-independent interface capable of interfacing, at least in part, the platform-independent application with any one of the distinct types of programmable platforms; and
(c) a platform-dependent interface situated on a predetermined programmable platform and capable of serving in conjunction with the platform-independent interface in interfacing the platform-independent application with the predetermined programmable platform;
(d) wherein the interface between the platform-independent application and the predetermined programmable platform is capable of being customized in accordance with user-specified criteria utilizing a graphical user interface for allowing a user to enter the user-specified criteria.
